(19) United States
(12) Patent Application Publication
(10) Pub. No.: US 2014/0146128 A1
(43) Pub. Date: May 29, 2014

(54) SYSTEM AND METHOD FOR PROVIDING VIDEO CONFERENCE SERVICE

(71) Applicant: ELECTRONICS AND TELECOMMUNICATIONS RESEARCH INSTITUTE, Daejeon-si (KR)

(72) Inventors: Young-Soo SHIN, Daejeon-si (KR); Seong MOON, Daejeon-si (KR); Ho-Yong RYU, Daejeon-si (KR); Jung-Sik KIM, Daejeon-si (KR); Sung-Back HONG, Daejeon-si (KR); Pyung-Koo PARK, Daejeon-si (KR); Ho-Sun YOON, Daejeon-si (KR); Sun-Cheul KIM, Daejeon-si (KR); Seung-Woo HONG, Daejeon-si (KR); Sang-Jin HONG, Gyeonggi-do (KR)

(73) Assignee: ELECTRONICS AND TELECOMMUNICATIONS RESEARCH INSTITUTE, Daejeon-si (KR)

(21) Appl. No.: 14/087,320

(22) Filed: Nov. 22, 2013

(30) Foreign Application Priority Data
Nov. 23, 2012 (KR) 10-2012-0133971

(51) Int. Cl. H04N 7/15

(52) U.S. Cl. CPC H04N 7/152
USPC 348/14.09

(57) ABSTRACT

A system for providing a video conference service is provided. The system includes a Multipoint Processor (MP) configured to process media occurring during a video conference so as to allow the processed media to be transmitted/received between user terminals; and one or more Multipoint Controller (MC) configured to control a session of a user terminal participating in a multi-participant video conference, wherein the MP and the MC are separate from each other.

### CROSS-REFERENCE TO RELATED APPLICATION

This application claims the benefit under 35 U.S.C. §119(a) of Korean Patent Application No. 10-2012-0133971, filed on Nov. 23, 2012, in the Korean Intellectual Property Office, the entire disclosure of which is incorporated herein by reference for all purposes.

### BACKGROUND

1. Field

The present invention relates to a video conference system, and more particularly, to a system and a method for supporting a video conference between multiple participants at distance using a multi-point processor.

2. Description of the Related Art

A video conference service allows a user to have a conference with other people at distance using a video/voice codec technology. According to a video/voice media quality, service infrastructure and a user terminal, the video conference service is called diversely, including telepresence, video conferencing, and Web conferencing, to name a few.

A multipoint control unit (MCU) is a core technology for providing a multi-participant video conference service. The MCU may be functionally split into a multi processor (MP) and a multipoint control unit (MC). The MP performs centralized media processing. That is, the MP receives a video, voice and data of a multi-participant video conference, and then mixes exchanges and distributes the same. Meanwhile, the MC sets up, maintain and terminate a conference. That is, the MC controls a session of a user terminal participating in a conference.

A high-definition multi-participant video conference service requires a great amount of network resources (a greater bandwidth), compared to an existing text- or web-based conference service. If it is to provide such a high-definition multi-participant video conference service using an existing network system, it is necessary to apply Qos in networks or use an exclusive line for the multi-participant video conference service.

However, a great amount of media data may be centralized during a multi-participant video conference service, so that a lack of network resources (a short bandwidth) may occur. In addition, there is a limitation on the amount of system resources which processes media for multiple parties participating in a conference. For these reasons, a video conference service may not be provided stably.

In order to solve the above problem, a method for placing a distributed multipoint control unit system was proposed. This method is to predict the number of user terminals participating in a video conference in consideration of the expensive costs of a multipoint control unit system and place the multipoint control unit system in a distributed manner according to the prediction. Yet, the above method is not useful in expanding the multipoint control unit system flexibly when more user terminals participate in a conference after the multipoint control unit system has been placed.

### SUMMARY

The following description relates to a system and method for providing a video conference service, and the system includes a Multipoint Processor (MP) configured to perform media processing and a Multipoint Controller (MC) configured to control overall operations of a video conference, wherein the MP and the MC are separate from each other so it is possible to flexibly expand a multipoint control unit system in response to an increase in users.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a general multi-participant video conference system;

FIG. 2 is a diagram illustrating a configuration of a multipoint control unit system according to an exemplary embodiment of the present invention;

FIG. 3 is a diagram illustrating a configuration in which multipoint processors (MPs) are hierarchally arranged;

FIG. 4 is a diagram illustrating a detailed configuration of a multipoint control unit (MC) according to an exemplary embodiment of the present invention;

FIG. 5 is a flow chart illustrating a procedure of collecting resource data for providing a multi-participant video conference according to an exemplary embodiment of the present invention; and

FIG. 6 is a flow chart illustrating a procedure of set up a multi-participant video conference according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

A video conference service is a service for providing a conference for participants at distance from each other using a video/voice codec technology. A multipoint control unit system is a core technology for providing a video conference service.

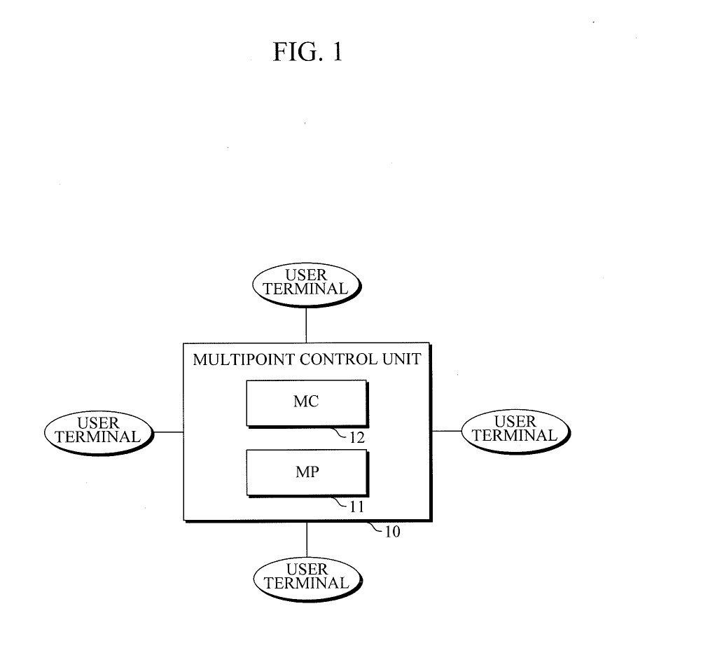

FIG. 1 is a diagram illustrating a configuration of a general multipoint control unit system.

Referring to FIG. 1, a multipoint control unit 10 functionally includes a multipoint processor (MP) 11 and a multipoint control unit (MC) 12.

The MP 11 receives from user terminals a video, voice and data occurring during a multi-participant video conference, and then mixes, exchanges and distributes the same. That is, the MP 11 primarily performs a media-related operation.

The MC 12 controls a conference procedure, including setting up, maintaining and terminating a multi-participant video conference. That is, the MC 12 controls a session of user terminals participating in a multi-participant video conference.

However, during a multi-participant conference service a large amount of media data is concentrated on the multipoint control unit 10, so that a lack of network resources (a short bandwidth) and a lack of system resources may occur. In order to solve the above problem, the multipoint control unit system needs to operate flexibly.

To that end, a multipoint control unit system in which an MP and an MC are physically separate from each other is provided in the following.

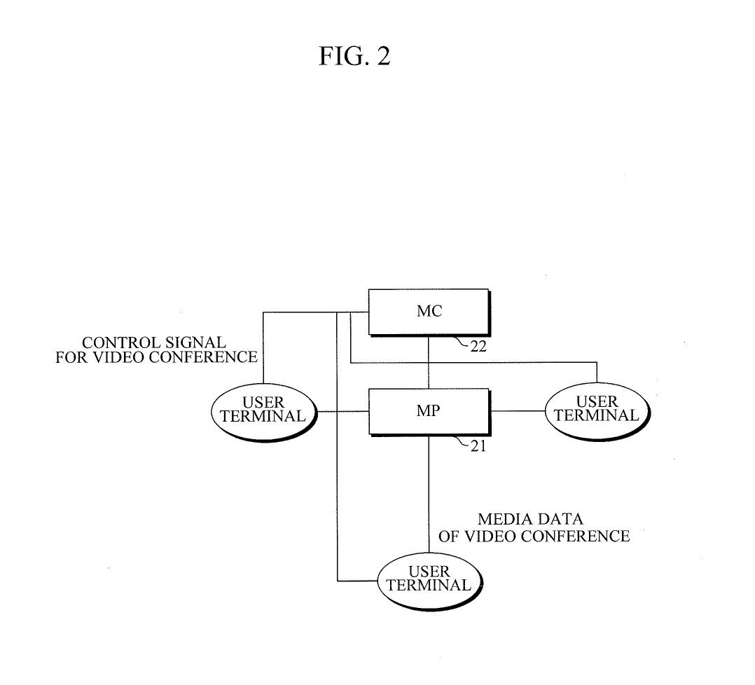

FIG. 2 is a diagram illustrating a configuration of a multipoint control unit system according to an exemplary embodiment of the present invention.

Referring to FIG. 2, an MP 21 and a MC 22 are different devices which are physically separate from each other and connected to user terminals 31, 32 and 33 individually.

As the MP 21 and the MC 22 are separated from each other, it is possible to expand the multipoint control unit system by selectively adding one of the MP 21 and the MC 22, rather than adding an additional multipoint control unit 10. In this manner, costs for expanding the multipoint control unit system may be reduced.

Hereinafter, explanations about hierarchically organized networks, each network in which an MP and an MC are separate from each other, will be provided. The MPs and the MCs are distributed to the hierarchically-organized networks in order to make it easy to expand an entire system. The networks may be hierarchically organized with various criteria, such as a size/local area of a network, a location of a user, and a corporation.

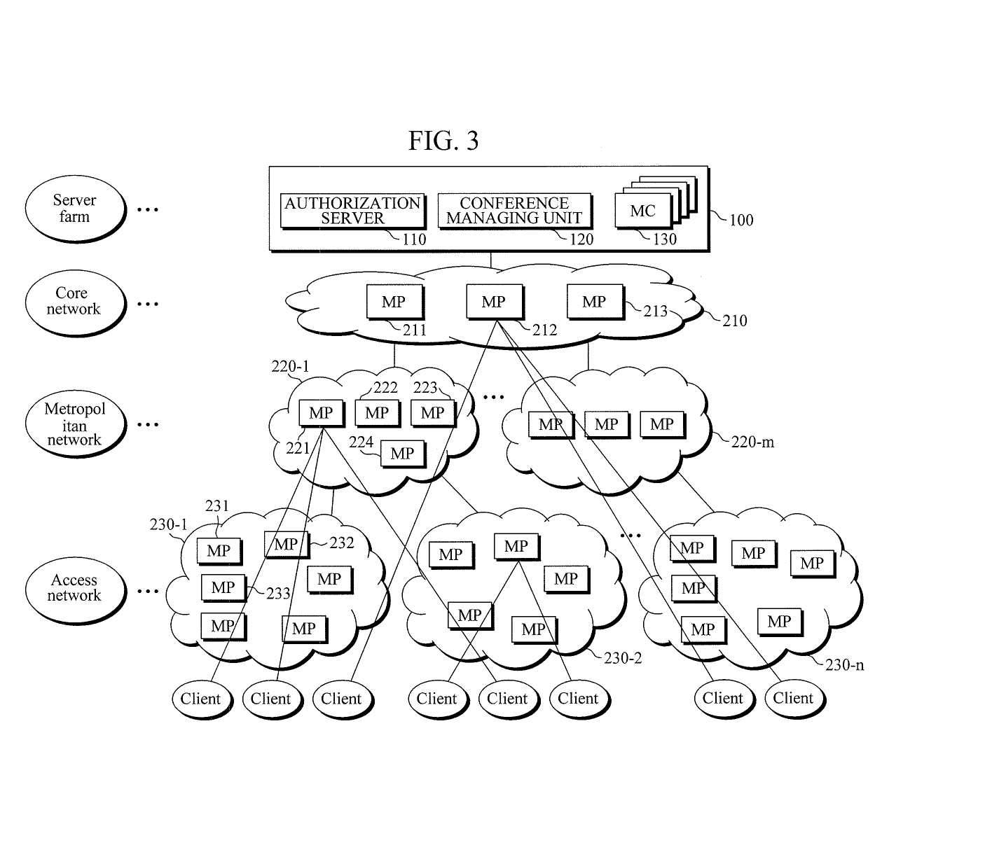

FIG. 3 is a diagram illustrating a configuration of a system for providing a video conference service according to an exemplary embodiment of the present invention.

Referring to FIG. 3, a video conference service providing system according to an embodiment includes one or more MCs 130 and one or more MPs 211, 212, . . . , 230-n which are distributed such as to be connected to the MC 130. The MCs 130 may be distributed to one or more system.

In one embodiment, it is possible to manage one or more MPs 211, 212, . . . , 230-n distributed to hierarchally-organized networks.

Referring to FIG. 3, networks may be organized hierarchically as a core network 210, metropolitan networks 220-1, 230-2, . . . , 230-n, and access networks 230-1, 230-2, . . . , 230-n. That is, one or more access networks constitute a metropolitan network, and one or more metropolitan networks constitute a core network.

A criterion for hierarchical organization of networks may be a size or a local area. If the criterion for hierarchical organization of networks is a size, two access networks, each network enabled to support a video conference among 48 people, constitute a metropolitan network enabled to support a video conference among 96 people. Similarly, two metropolitan s networks, each network enabled to support a video conference among 96 people, constitute a core network enabled to support a video conference among 194 people. Alternatively, if the criterion for hierarchal organization of networks is a local area of a network, an access network may correspond to a district-level local area, with a metropolitan network corresponding to a county-level local area and a core network corresponding to a city-level local area.

MPs are distributed to the hierarchically-organized networks 210, 220-1, . . . , 230-n according to a size of a network. In addition, if some local areas have the same size, a user demand is taken into consideration so that MPs are distributed to the hierarchically-organized networks 210, 220-1, . . . , 230-n according to a data processing capacity of an MP. Each MP distributed to the same network may have a different data processing capacity. For example, a predetermined number of MPs distributed to an access network may have different data processing capacities according to the number of user terminals.

At the highest level of the hierarchally-organized networks is a server farm 100 which manages the entire networks. The server farm 100 includes an authorization server 110, a conference managing unit 120 and one or more MCs 130.

The authorization server 110 authorizes user terminals participating in a video conference. The conference managing unit 120 provides a video conference service, such as scheduling, participating in and search for a video conference. Both the authorization server 110 and the conference managing unit 120 operate in association with the MC 130.

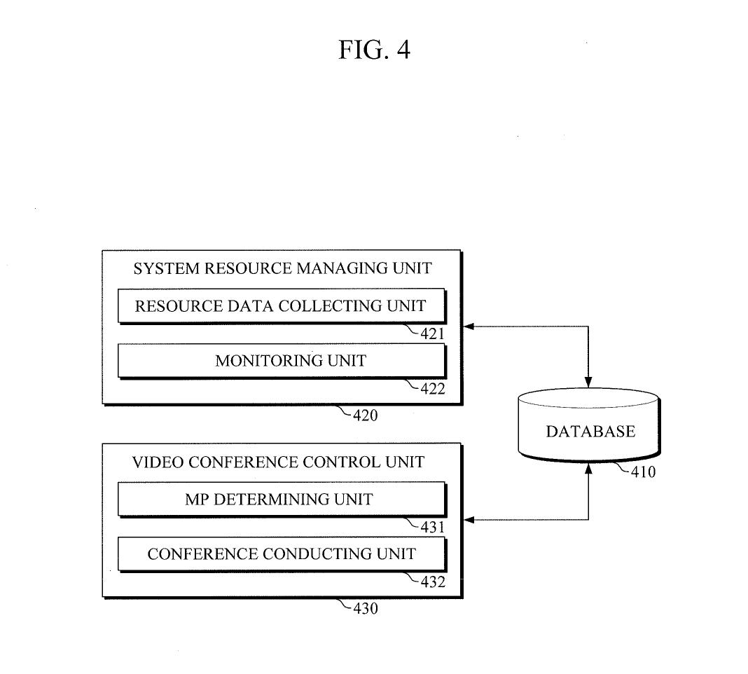

The MC 130 manages resource data of the distributed MPs 210, 220 and 230, and supports a conference by determining an MP for setting up a conference in response to a request from a user terminal. The functions of the MC 130 will be described in detail with reference to FIG. 4.

FIG. 4 is a diagram illustrating a configuration of a MC according to an exemplary embodiment of the present invention.

Referring to FIG. 4, an MC includes a database 410, a system resource managing unit 420, and a video conference control unit 430.

In the database 410, information of hierarchically-organized networks and information of MPs distributed to each of the hierarchically-organized networks are stored. More specifically, the information of hierarchically-organized networks may include a size and a local area of each network, and the number, identification information and all the data processing capacity of MPs distributed to each network. The information of MPs distributed to each of the hierarchically-organized networks may include identification information and a processing capacity of a corresponding network, the number of on-going conferences, and the number of user terminals participating in each of the on-going conference.

More specifically, the system resource managing unit 420 includes a resource data collecting unit 421 and a monitoring unit 422.

The resource data collecting unit 421 receives a state of network resources and a state of system resources from the MPs to thereby update the database 410. For example, if the number of user terminals increases, the increased number of user terminals is updated in the database 410.

The monitoring unit 422 monitors the database 410 in real time so as to determine whether to add an additional MP according to a resource state. That is, if the system needs to be expanded as more user terminals participates in a conference, the monitoring unit 422 determines a capacity of an MP and a network to which the MP with the corresponding capacity is to be distributed, as a way of finding out the best solution. The monitoring unit 422 may output the best solution to a user terminal of a manager. Then, based on above information, the managing unit may add the MP with a determined capacity to a determined network.

More specifically, the video conference control unit 430 includes an MP determining unit 431 and a conference conducting unit 432.

In response to a request for setting up a conference from a user terminal participating in a multi-participant video conference, the MP determining unit 431 searches the database 410 so as to determine an MP optimized for the requested conference and informs the user terminal of the optimized MP.

In order to be informed of an optimized MP, the user terminal transmits information about a conference to the MP determining unit 431. The information about a conference includes a type of the requested conference, and locations and the number of user terminals participating in the conference, and a data transmission capacity required for the conference.

Then, the MP determining unit 431 determines an optimized MP based on the information about a conference and a resource state (that is, the number of on-going conferences and the number of parties participating in each conference) and a network state (that is, a currently used bandwidth and a bandwidth to be possibly used) of each MP. Then, the MP determining unit 431 informs the user terminal of the determined optimized MP.

In one example, if all the user terminals participating in a conference belong to the same access network, the MP determining unit 431 may determine as an optimized MP one of the MP distributed to the same access network. In another example, if user terminals participating in a conference belong to different access network, the MP determining unit 431 may determine as an optimized MP an MP that is distributed to a metropolitan network or core network which embraces different access networks. As a user terminal transfers media data to the determined MP, media traffic is optimally distributed at a network level. In this way, a user may receive a high-definition video conference service.

In addition, the MP determining unit 431 determines the optimized MP based on a data transmission capacity required for a conference and the number of user terminals participating in the conference among a plurality of MPs distributed to a corresponding network, and informs the user terminal of the optimized MP. Then, the user terminal accesses the optimized MP so as to request a conference.

If the conference is set up by the determined MP, the conference conducting unit 432 authorizes the user terminal and manages the conference in association with the authorization server 110 and the conference managing unit 120.

Hereinafter, a method for providing a multi-participant video conference service in the above-described system in which networks are hierarchically organized will be described. According to an exemplary embodiment of the present invention, the method for providing a multi-participant video conference service largely includes an operation of collecting resource data required for providing a multi-participant video conference and an operation of setting up a video conference.

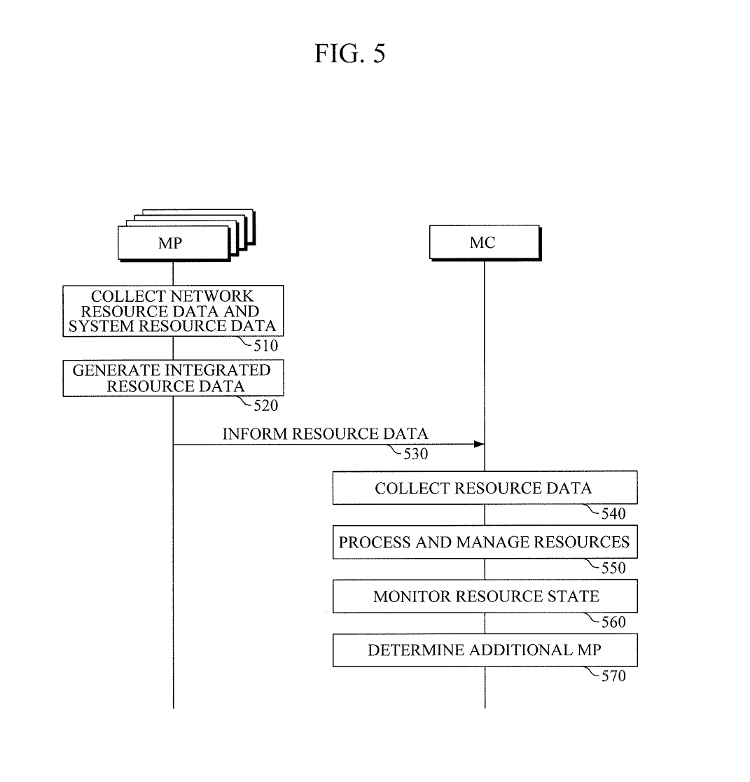

FIG. 5 is a flow chart illustrating a procedure of managing system resources in order to provide a multi-participant video conference service according to an exemplary embodiment of the present invention.

Referring to FIG. 5, one or more distributed MPs collect resource data and network data in 510. The resource data includes the number of on-going conferences and the number of participant of each conference, a currently used bandwidth, and a bandwidth to be possibly used. In addition, the MPs are distributed to networks which are hierarchically organized.

The MPs integrates and process the resource data and the network data to be used as resource data in 520. Each MP informs an MC of the resource data in 530.

Next, the MC collects the resource data from one or more MPs in 540. Next, the MC processes the resource data to be in a systematical management structure by classifying the hierarchically-organized networks in 550.

Next, the MC monitors an entire resource state of the video conference system using the systematic resource management structure in 560.

If a monitoring result shows that it is necessary to add an additional MP as more user terminals are participating in the video conference, the MC determines an additional MP in 570. That is, if a result of monitoring an entire resource state shows that the system needs to be expanded due to an increase in the number of users, a processing capacity of an MP and a network to which the MP with the corresponding capacity is distributed are informed as the best solution. Then, a manager may arrange the MP with the corresponding capacity in the network based on the above information.

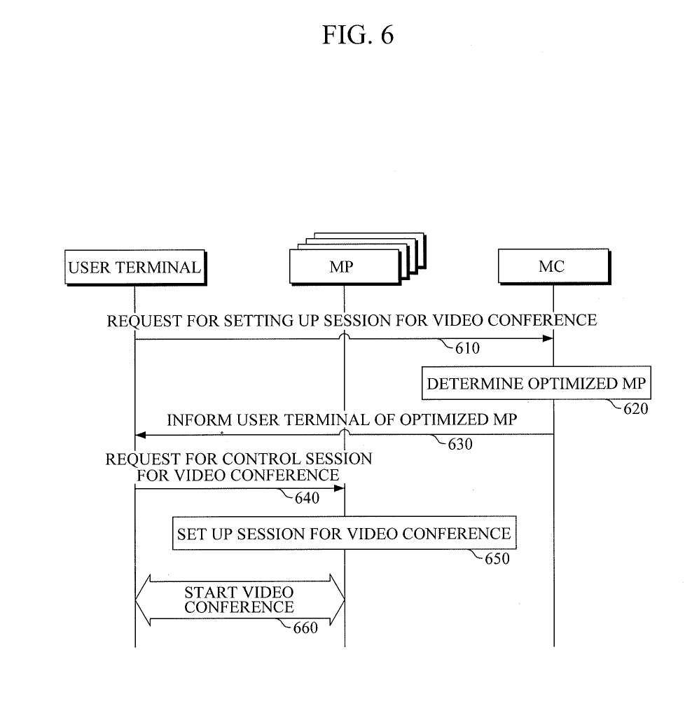

FIG. 6 is a flow chart illustrating a procedure of setting up a multi-participant video conference according to an exemplary embodiment of the present invention.

Referring to FIG. 6, a user terminal requests an MC to set up a session for a video conference in 610. At this time, the user terminal transmits information about a requested video conference to the MC. The information about the requested video conference includes the number of user terminals going to participate in the video conference, locations of the user terminals, and a required amount of data usage according to a type of the video conference.

Next, the MC determines an MP optimized for processing media of a high-definition video conference in 620. At this time, the MC determines the optimized MP by reflecting locations and policies of the user terminals based on a state of network resources and a state of system resources, and the network resources and the state resources are hierarchically managed. For example, if the video conference is conducted among users located within a building, the MC may determine one of MPs distributed to an access network as an optimized MP. In another example, if the video conference is conducted among users at distant locations, such as between Seoul and Pusan, the MC may determine as an optimized MP an MP that is distributed to a core network. In yet another example, if the number of parties participating in a video conference exceeds a predetermined number, a large-capacity MP may be determined an optimized MP.

Next, the MC informs the user terminal of the optimized MP in 630.

Next, the user terminal requests that the optimized MP control a video media session in 640.

Next, the MP sets up a media session for a multi-participant video conference in 650. If the session is set up, the MP informs the MC of a video conference service. Then, the MC transmits information about the video conference service to the conference managing unit 120. In addition, the MC controls the authorization server 110 to authorize the user terminals going to participate in the video conference.

Then, one or more user terminals start the video conference by transmitting data to one another in 660.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multipoint control unit (MC) comprising:
a database configured to store resource data of one or more distributed multipoint processors (MPs); and
a video conference control unit configured to, in response to a request for a conference from a user terminal, search the database so as to determine an MP for processing media occurring during the conference, and to inform the user terminal of the determined MP.

2. The MC of claim 1, further comprising:
a system resource managing unit configured to update the database by collecting resource data information from the one or more MPs.

3. The MC of claim 2, wherein the system resource managing unit generates the resource data information of a structure in which the resource data information is classified into hierarchically-organized networks including MPs, and stores the generated resource data in the database.

4. The MC of claim 2, wherein the resource data information comprises at least one of a number of ongoing conferences, a number of user terminals participating in each conference, a currently used bandwidth and a bandwidth to be possibly used.

5. The MC of claim 2, wherein the system resource managing unit monitors the database in real time and determine whether to add an additional MP according to a resource state.

6. The MC of claim 1, wherein the video conference control unit receives a type of the conference requested by the user terminal, a number and locations of user terminals participating in the conference, and a data transmission capacity required for the conference.

7. The MC of claim 1, wherein the video conference control unit determines an optimized MP based on information on the requested conference, the information which is received from the user terminal, and a resource state and a network state of each of the MPs.

8. The MC of claim 1, wherein, in response to the conference being set up by the determined optimized MP, the video conference control unit authorizes the user terminal and manages the conference in association with an authorization server and a conference managing unit.

9. A method for providing a video conference service by a multipoint control unit (MC) which is in association with one or more distributed multipoint processors (MPs), the method comprising:
collecting resource data and network data from the one or more distributed MPs; and
if an additional MP needs to be added according to a result of monitoring the collected network data, determining the additional MP to be transmitted.

10. The method of claim 9, wherein between the collecting and the determining is processing the resource data and the network data to be in a systematic management structure by classifying the resource data and the network data into hierarchically-organized networks.

11. A method for providing a multi-participant video conference service by a multipoint control unit (MC) which is in association with one or more distributed multipoint processors (MPs), the method comprising:
receiving a request from a user terminal to set up a conference session;
determining an MP optimized for processing media; and
inform the user terminal of the determined MP.

12. The method of claim 11, wherein the determining of the optimized MP comprises determining the optimized MP by reflecting locations and policies of parties participating in a conference based on a state of network resources and a state of system resources, wherein the network resources and the system resources are hierarchically managed.

13. The method of claim 11, further comprising controlling authorization and management of user terminals participating in the conference.
